(19) United States
(12) Patent Application Publication
(10) Pub. No.: US 2002/0041677 A1
(43) Pub. Date: Apr. 11, 2002

(54) Low voltage DC powered telecommunications customer service terminal having telephone wire interconnection and a hot-swappable low voltage battery module

(76) Inventors: Craig S. Cambier, Louisville, CO (US); James A. Bloemen, Highlands Ranch, CO (US)

Correspondence Address: Earl C. Hancock, HOLLAND & HART LLP, P.O. Box 8749, Denver, CO, 80201, US

(21) Appl. No.: 09/872,084

(22) Filed: May 31, 2001

Related U.S. Application Data
(60) Provisional application No. 60/209,277, filed on Jun. 2, 2000.
(60) Provisional application No. 60/279,910, filed on Mar. 29, 2001.

(51) Int. Cl. H04M 11/00; H02J 7/00

(52) U.S. Cl. 379/399.01; 379/93.01; 379/93.05; 320/112

(57) ABSTRACT

A telecommunications system includes a digital subscriber line, a plurality of analog telephone terminals, at least one digital data terminal, a power supply having a high voltage alternating current input and a low voltage direct current output, and a telecommunications customer service terminal (CST) having a signal input terminal for connection to the digital subscriber line (DSL), having a plurality of analog telephone output terminals for connection to individual ones of the plurality of analog telephone terminals, having at least one digital data output terminal for connection to the at least one digital data terminal, and having a low voltage direct current power input terminal for connection to the low voltage direct current output of the power supply. A length of telephone wire connects the signal input terminal of the CST to the digital subscriber line, a plurality of lengths of telephone wire connect individual ones of the analog telephone output terminals of the CST to individual ones of the plurality of analog telephone terminals, at least one length of telephone wire connects the at least one digital data output terminal of the CST to the at least one digital data terminal, and a length of telephone wire connects the low voltage direct current power terminal of the CST to the low voltage direct current output of the power supply. A manually removable battery pack supplies low voltage direct current to the low voltage direct current input terminal of the CST upon failure of the high voltage alternating current input to the power supply.

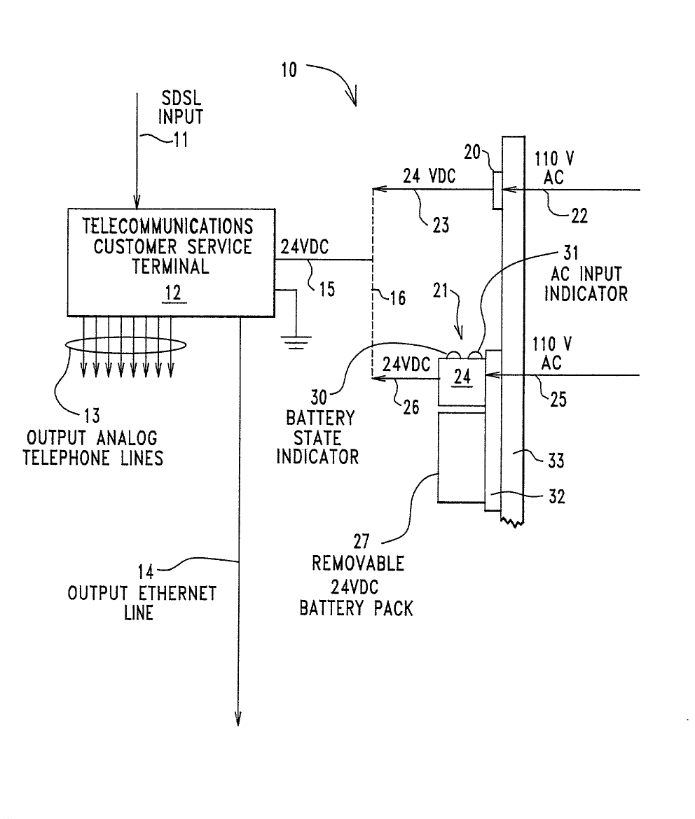

### CROSS-REFERENCE TO RELATED APPLICATIONS

This non-provisional patent application claims the benefit of copending provisional patent application Serial No. 60/209,277 filed Jun. 2, 2000 and entitled INTEGRATED TELECOMMUNICATIONS ACCESS DEVICE USING SDSL, incorporated herein by reference.

This non-provisional patent application claims the benefit of copending provisional patent application Serial No. 60/279,910 filed Mar. 29, 2001 and entitled TELECOMMUNICATIONS CUSTOMER SERVICE TERMINAL, incorporated herein by reference.

Design patent application Ser. No. 29/138,897 filed Mar. 21, 2001 and entitled BACKUP POWER PACK.

Design patent application Ser. No. 29/138,901 filed Mar. 21, 2001 and entitled TELECOMMUNICATIONS CUSTOMER SERVICE TERMINAL.

Non-provisional patent application Serial No. xx/xxx,xxx filed May ______, 2001 and entitled LOW VOLTAGE DC POWERED TELECOMMUNICATIONS CUSTOMER SERVICE TERMINAL HAVING OPTIONAL HOT-SWAPPABLE LOW VOLTAGE BATTERY MODULE.

### BACKGROUND OF THE INVENTION

1. Field of the Invention

This invention relates to the field of telecommunications, and more specifically to a telecommunications Customer Service Terminal (CST) that is operable to deliver carrier-class analog voice and digital data to a telephone user such as a home or a small business.

2. Description of the Related Art

The use of telecommunications customer service terminals, also known as Integrated Access Devices or IADs, is known. However, there is a need in the art for a small, simple, inexpensive and conveniently-wireable CST that provides both analog voice and digital data to a relatively small-need telecommunications users.

### SUMMARY OF THE INVENTION

This invention provides a telecommunications CST wherein all of the input and output wiring comprises telephone wire that is readily available to personnel that install the CST. Relative to this feature of the invention, most telephone installation trucks carry quantities of relatively inexpensive 24, 26 and 28 gage telephone wire. This invention provides that readily available telephone wire of this type is used to connect the CST to its low voltage DC input power, to an input telecommunications line, and to the various telephones and data terminals that are serviced by analog/digital outputs of the CST.

This invention provides a small, simple and inexpensive single line entry telecommunications CST that is powered by low voltage Direct Current (DC) in the absence of an on/off switch. That is, so long as the CST is provided with a low voltage DC input, the CST remains operative or remains in an on state.

A low-voltage DC power supply may be used that includes a manually-removable and “hot swappable” low voltage battery pack that operates to bridge failure of a primary high voltage alternating current (AC) power input to the low voltage power supply.

Low-voltage DC power is supplied to the CST in the absence of an on/off switch by selecting for use either (1) a first power supply whose input is a high voltage AC (for example, 110 VAC) and whose output is a low voltage DC (for example, 24 VDC), or (2) a second power supply module whose input is a high voltage AC (for example, 110 VAC), whose output is a low voltage DC (for example, 24 VDC), and which includes a manually-removable DC battery pack that operates to supply a low voltage DC output should the high voltage AC input to this second type of power supply fail.

Since the CST does not have an on/off switch, only the present of a low voltage DC input is required to render the CST operative. Should the above-mentioned AC power failure for this second type of power supply extend for a relatively long time interval, for example eight hours, the currently in use DC battery pack may have to be replaced with a freshly charged DC battery pack. In this event, the CST experiences only a short period of inoperativeness while the old battery pack is manually removed and a freshly charged battery pack is manually inserted.

This second type of power supply module includes circuitry that is operable to monitor the state of charge of the manually removable DC battery pack, as well as circuitry that responds to the presence or absence of a high voltage AC input.

Indicators such as Light Emitting Diodes (LEDs) are provided to indicate the state of charge of the DC battery pack and to indicate the active/inactive state of the high voltage AC power.

This second type of power supply is constructed and arranged such that, so long as high voltage AC input power is applied thereto, manual removal and replacement of the DC battery pack can be affected without disturbing the supplying of low voltage DC power to the CST, i.e. the battery pack can be “hot swapped” while the CST continuously remains operative.

Since all wiring to and from the CST carries low voltage, readily available and low cost American Wire Gage (AWG) telephone wire is used to apply low voltage DC operating power to the CST, telephone wire is used to connect a symmetrical digital subscriber line (or more generically a digital subscriber line) to an input of the CST, and telephone wire is used to connect the CST's various output terminals to analog telephones and digital data terminals.

### BRIEF DESCRIPTION OF THE DRAWING

The single FIGURE of this application shows a telecommunications system that includes the invention.

### DESCRIPTION OF THE PREFERRED EMBODIMENT

The single FIGURE shows a telecommunications system 10 that includes the invention. Telecommunications input to system 10 is provided by way of a symmetrical digital subscriber line (SDSL) 11. CST 12 operates upon SDSL input 11 to provide a plurality of analog output lines 13 that are adapted to be connected to a like plurality of telephone terminals (not shown). CST 12 also operates upon SDSL input 11 to provide at least one digital Ethernet output line 14 to a digital data terminal (not shown).

Analog output lines 13 are sometimes called POTS lines, a term that stands for plain old telephone service lines. Traditionally, phone service that connects a home or a small business to a telephone company office over copper wires comprises POTS lines, or wires that are wound around each other and called a twisted pair. This traditional service was created to enable the exchange of voice information with other telephone users by way of analog signals.

As is known, SDSL 11 is a type of digital subscriber line (DSL) that is similar to high-bit rate HDSL wherein a single twisted-pair line carries 1.544 Mbps (U.S. and Canada) or 2.048 Mbps (Europe) in each direction on a duplex line that is symmetric because the data rate is the same in both directions.

DSL is a technology for bringing high bandwidth information to homes and small businesses over ordinary copper telephone lines, wherein xDSL refers to different variations of DSL, such as, but not limited to, ADSL, CDSL, HDSL, IDSL, RADSL, SDLS, UDSL and VDSL. A DSL can carry both data and voice signals wherein the data part of the line is continuously connected.

Assuming that the home or small business is close enough to a telephone company central office that offers DSL, the home or small business may be able to receive data at rates up to 6.1 megabits per second, thus enabling continuous transmission of motion picture video, audio, and even 3-dimensional effects.

While telecommunications system 10 will be described as having a SDSL input 11, its spirit and scope includes virtually any type of DSL 11.

Grounded low-voltage DC input power (i.e., 24 VDC) is applied to CST 12 by way of a telephone wire 15. As shown by dotted line 16, 24 VDC power 15 is optionally supplied by a first wall-mounted power supply 20 or by a second wall-mounted power supply 21, by way of the respective telephone wires 23 or 26.

Power supply 20 is of a well known type that receives a high-voltage input, such as 110 VAC input 22, and operates to supply a low-voltage DC output, such as 24 VDC, on telephone wire 23.

Power supply 21 includes a first component 24 that operates similar to power supply 20. That is, as long as 110 VAC input 25 to power supply 24 remains active, 24 VDC telephone wire output 26 of component 24 remains active. In addition, power supply 21 includes a manually-replaceable 24 VDC battery pack 27 that constitutes a hot swappable backup power supply for component 24 and AC input 25.

Circuitry within component 24 (not shown) operates to activate a battery-state indicator 30 in accordance with the state of charge of 24 VDC battery pack 27.

Power supply 21 is constructed and arranged so that when indicator 30 indicates the need to manually remove a 24 VDC battery pack 27 that is currently resident on base member 32, that particular battery pack 27 can be removed and replaced with a fully charged battery pack 27. So long as 110 VAC input 25 to power supply 21 remains active, this removal and replacement of a battery pack 27 does not interrupt operation of CST 12.

In this construction and arrangement of telecommunications system 10, all wiring, with the exception of 110 VAC inputs 22 and 25, is American Wire Gage (AWG) telephone wiring, such as 24, 26, or 28 gage telephone wire that is readily available to telecommunications workers who are building or connecting system 10.

CST 12 and power supply 20 or power supply 21 may be mounted in relatively close proximity to each other, for example on a vertically extending wall 33. Optionally the housing of CST 12 may be a weather-proof housing that is constructed and arranged for mounting out of doors.

Since CST 12 does not have an on/off switch, only the present of low voltage DC input 15 is required to render CST 12 operative. Should AC power 25 fail for an extend period of time, for example for eight hours, indicator 30 may indicate that a currently in use DC battery pack 27 should be replaced by a freshly charged DC battery pack 27, whereupon CST 12 experiences only a short period of inoperativeness as the old battery is removed and a fresh battery is inserted in power supply 21.

What is claimed is:

1. A telecommunications system, comprising:
a digital subscriber line;
a plurality of analog telephone terminals;
at least one digital data terminal;
a power supply having a high voltage alternating current input and a low voltage direct current output;
a telecommunications customer service terminal having a signal-input terminal for connection to said digital subscriber line, having a plurality of analog telephone output terminals for connection to individual ones of said plurality of analog telephone terminals, having at least one digital data output terminal for connection to said at least one digital data terminal, and having a low voltage direct current power input terminal for connection to said a low voltage direct current output of said power supply;
said telecommunications customer service terminal being constructed in the absence of an on/off switch, such that said telecommunications customer service terminal remains continuously active so long as a low voltage direct current is continuously supplied to said low voltage direct current power-input terminal;
a length of telephone wire connecting said signal-input terminal of said telecommunications customer service terminal to said digital subscriber line;
a plurality of lengths of telephone wire connecting individual ones of said analog telephone output terminals of said telecommunications customer service terminal to individual ones of said plurality of analog telephone terminals;
at least one length of telephone wire connecting said at least one digital data output terminal of said telecommunications customer service terminal to said at least one digital data terminal; and
a length of telephone wire connecting said low voltage direct current power terminal of said telecommunications customer service terminal to said low voltage direct current output of said power supply.

2. A telecommunications system, comprising:
a power supply having a high voltage alternating current input and a low voltage direct current output;
a telecommunications customer service terminal having a signal input terminal connected to a digital subscriber line, having a plurality of analog telephone output terminals connected to individual ones of a plurality of analog telephone terminals, having at least one digital data output terminal connected to at least one digital data terminal, and having a low voltage direct current input terminal for connection to said low voltage direct current output of said power supply; and
a length of AWG telephone wire connecting said low voltage direct current input terminal of said telecommunications customer service terminal to said low voltage direct current output of said power supply.

3. The telecommunications system of claim 2 wherein said telecommunications customer service terminal is constructed in the absence of an on/off switch, such that said telecommunications customer service terminal remains continuously active so long as a low voltage direct current is continuously supplied to said low voltage direct current power input terminal, and wherein said power supply includes:
a manually-removable battery pack that is operable to supply a low voltage direct current to said low voltage direct current input terminal of said telecommunications customer service terminal upon failure of said high voltage alternating current input to said power supply, said battery pack being replaceable with a different battery pack when said battery pack becomes discharged or relatively discharged in the presence of a failure of said high voltage alternating current input to said power supply.

4. A method of constructing a telecommunications system, comprising;
providing a digital subscriber line;
providing a plurality of analog telephone terminals;
providing at least one digital data terminal;
providing a power supply having a high voltage alternating current input and a low voltage direct current output;
providing a telecommunications customer service terminal having a signal input terminal for connection to said digital subscriber line, having a plurality of analog telephone output terminals for connection to individual ones of said plurality of analog telephone terminals, having at least one digital data output terminal for connection to said at least one digital data terminal, and having a low voltage direct current power input terminal for connection to said a low voltage direct current output of said power supply;
said telecommunications customer service terminal being constructed in the absence of an on/off switch, such that said telecommunications customer service terminal remains continuously active so long as a low voltage direct current is continuously supplied to said low voltage direct current power input terminal;
providing a length of telephone wire connecting said signal input terminal of said telecommunications customer service terminal to said digital subscriber line;
providing a plurality of lengths of telephone wire connecting individual ones of said analog telephone output terminals of said telecommunications customer service terminal to individual ones of said plurality of analog telephone terminals;
providing at least one length of telephone wire connecting said at least one digital data output terminal of said telecommunications customer service terminal to said at least one digital data terminal; and
providing a length of telephone wire connecting said low voltage direct current power terminal of said telecommunications customer service terminal to said low voltage direct current output of said power supply.

5. The method of claim 4 including:
providing a manually removable battery pack within said power supply;
said battery pack being operable to supply a low voltage direct current to said low voltage direct current input terminal of said telecommunications customer service terminal upon failure of said high voltage alternating current input to said power supply, said battery pack being replaceable with a different battery pack when said battery pack becomes discharged or relatively discharged in the presence of a failure of said high voltage alternating current input to said power supply.
